(19) United States
(12) Patent Application Publication
(10) Pub. No.: US 2006/0050143 A1
(43) Pub. Date: Mar. 9, 2006

(54) High-frequency treatment tool for endoscope

(75) Inventor: Teruo Ouchi, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/218,778

(22) Filed: Sep. 6, 2005

(30) Foreign Application Priority Data
Sep. 6, 2004 (JP) 2004-257892

(51) Int. Cl. H04N 7/18; H04N 9/47; A62B 1/04

(52) U.S. Cl. 348/65

(57) ABSTRACT

A high-frequency treatment tool for an endoscope including a sheath and an electrode is provided. The sheath is e inserted through a forceps channel of the endoscope, and is made of electrically insulating material. A high frequency electrical current is supplied to the electrode for the high-frequency treatment. At least a part of the endoscope to be contacted with mucous membrane is formed with a coating of one of gold, platinic metal and its alloy.

### BACKGROUND OF THE INVENTION

The present invention relates to a high-frequency treatment tool which is inserted through a forceps channel of an endoscope and used for incision of mucous membranes of in vivo tissues inside a human cavity.

The high-frequency treatment tool is widely used and examples of such a tool are disclosed in Japanese Patent Provisional Publications No. P2002-113016A and No. P2002-153484A.

When the high-frequency treatment tool is used for the incision, an electrical current with a high-frequency flows at a portion where electrodes of the high-frequency treatment tool contact the mucous membranes, and Joule heat is generated. With the Joule heat, cautery of the surface of the in vivo tissues is carried out, thereby the incision is performed.

Once the high-frequency treatment as above is performed, the surfaces of the electrodes are oxidized, and thereafter, the living tissues easily stick to the electrode surfaces. Specifically, when the high temperature is generated as the high-frequency current flows, protein substances stick onto the electrode surfaces and are charred. Further, onto the charred protein substances, fat substances stick. In such a state, the conductivity of the high-frequency electrodes is significantly deteriorated. Therefore, generally, a user of the high-frequency treatment tool withdraws the tool from the forceps channel and cleans the same, or replace the tool with a new one. As above, when the conventional high-frequency treatment tool is used, relatively complicated operations (i.e., withdrawal and cleaning/replacement) should be done quickly during the incision or the like.

### SUMMARY OF THE INVENTION

The present invention is advantageous in that an improved high-frequency treatment tool for an endoscope is provided. According to the improved high-frequency treatment tool, when the high-frequency treatment operation is performed, cauterized human tissues hardly stick on the high-frequency electrodes. Therefore, it is possible to use the tool repeatedly without performing the troublesome operation (e.g., cleaning/replacing of the high-frequency treatment tool) during an incision operation.

According to an aspect of the present invention, a high-frequency treatment tool for an endoscope including a sheath to be inserted through a forceps channel of the endoscope is provided, and the sheath being made of electrically insulating material. The high-frequency treatment tool includes an electrode to which a high-frequency electrical current is supplied for the high-frequency treatment. At least a part of the electrode to be contacted with mucous membrane is formed with a coating of one of gold, platinic metal and its alloy.

Optionally, the electrode may be made of one of stainless steel and tungsten alloy.

Optionally, the coating may be made of one of plating, evaporating, and ion plating.

Optionally, the electrode may be formed such that a tip end portion has a flat and expanded round shape. Optionally, the electrode may be formed to have a shape of a hook. Optionally, the electrode may be formed to have a shape of a needle.

According to an another aspect of the present invention, a high-frequency snare for an endoscope including a sheath to be inserted through a forceps channel of the endoscope is provided, and the sheath being made of electrically insulating material. The high-frequency snare includes an electrode to which a high-frequency electrical current is supplied for the high-frequency treatment. The electrode is connected at end portions to form a loop. At least a part of the electrode to be contacted with mucous membrane is coated with one of gold, platinic metal and its alloy.

Optionally, the electrode may be configured to protrude from the sheath and expand outside the sheath.

Optionally, the electrode may be configured to be retracted and partially tucked into the sheath so that at least a part of the electrode may be protruded from the sheath to serve as a cautery tool.

### BRIEF DESCRIPTION OF THE DRAWINGS

FIG. 1 is a cross-sectional side view of a tip portion of a high-frequency treatment tool according to a first embodiment of the invention.

FIG. 2 shows an exemplary scene where the incision of human tissues is performed using the high-frequency treatment tool according to the first embodiment of the invention.

FIG. 3 shows an exemplary scene where detachment of human tissues are performed using the high-frequency treatment tool according to the first embodiment of the invention.

FIG. 4 shows an exemplary scene where a hemostatic operation is performed on a portion where the human tissues are detached using the high-frequency treatment tool according to the first embodiment of the invention.

FIG. 5 is a cross-sectional side view of a tip portion of a high-frequency treatment tool according to a second embodiment of the invention.

FIG. 6 is a cross-sectional side view of a tip portion of a high-frequency treatment tool according to a third embodiment of the invention.

FIG. 7 is a cross-sectional side view showing a state in which high-frequency electrode is protruded from a sheath and expanded according to a fourth embodiment of the invention.

FIG. 8 is a cross-sectional side view shown a state in which the high-frequency electrode is retracted and tucked into the sheath according to the fourth embodiment of the invention.

### DETAILED DESCRIPTION OF THE EMBODIMENTS

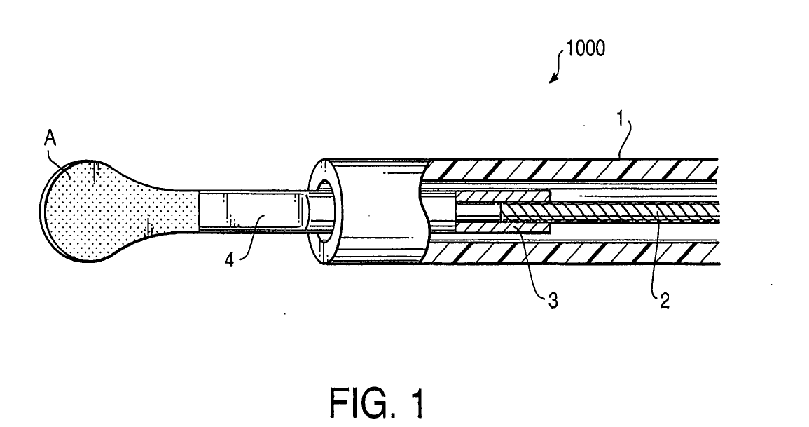

FIG. 1 is a cross-sectional side view of a tip portion of a high-frequency treatment tool 1000 according to a first embodiment of the invention. The high-frequency treatment tool 1000 is to be inserted in a forceps channel of an endoscope (not shown). The high-frequency treatment tool 1000 includes a sheath 1 which is a flexible tubular member having electrically insulating property. For example, the sheath 1 is an elastic resin tube made of ethylene tetrafluoride material. As shown in FIG. 1, inside the sheath 1, an operation wire 2 (which is a electrically conductive wire made of, for example, one of stainless steel) is inserted over the entire length of the sheath 1. The operation wire 2 is movable along an axis of the sheath (i.e., in the axial direction of the sheath 1).

At the tip of the operation wire 2, a high-frequency electrode 40 is fixed with a connection pipe 3 made of metal. The high-frequency electrode 40 is made of stainless steel, and is configured to be protruded/retracted from the tip end of the sheath 1. The high-frequency electrode 40 is formed such that a tip end half thereof has a flat and expanded round shape.

The operation wire 2 can be driven to move in the axial direction of the sheath 1 as an operation unit (not shown) connected to the proximal end of the wire 5 is operated.

The surface of the tip end portion A of the electrode 40, as shown by hatching with dots, is overlaid with gold. Although the entire electrode 40 can be overlaid with gold, at least the tip end portion A of the electrode 40 is overlaid with gold, a desired operation can be done using the electrode 40.

The area of the electrode 40 to be overlaid with gold may be the entire area of the electrode 40. In view of practical use, however, only an area which may contact the human tissues during the cautery operation may be coated. The portion A, which is overlaid with gold, will not be oxidized easily by the heat generated when the high-frequency treatment is carried out using the electrode 40. Therefore, the cauterized human tissues will not stick to the electrode 40.

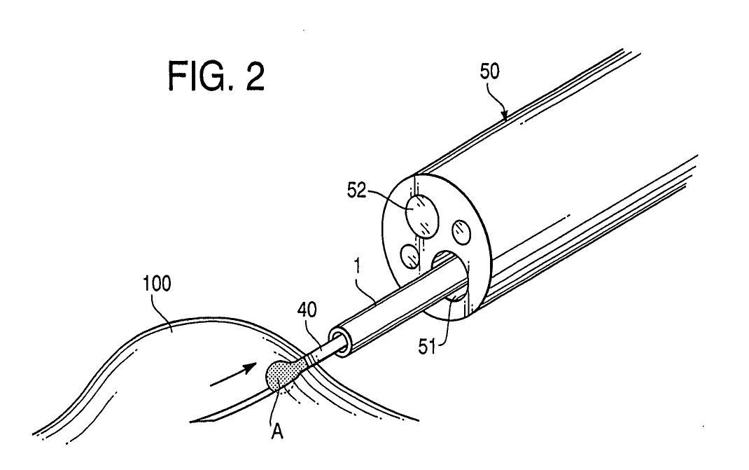

FIG. 2 shows an exemplary scene where the incision of human tissues is performed using the high-frequency treatment tool 1000 according to the first embodiment of the invention. As shown in FIG. 2, the tip end portion of the sheath 1 is protruded from the forceps channel 50 of the endoscope 50, and is located within a field of view of an observation window 52 of the endoscope 50.

When the incision is performed, the high-frequency electrode 40 abuts against the human tissues 100 in an upright state (i.e., with a plane of the electrode 40 being substantially perpendicular to the surface of the human tissues 100). Then, as the high-frequency electrode 40 is slid by operating the operation wire 2 toward the sheath 1, a position where the high-frequency electrode 40 contacts the human tissues 100 is cut.

When the incision is performed as above, since the portion A of the electrode 40 that contacts the human tissue 100 is coated with gold, even if the electrode 40 is heated to have a relatively high temperature, the cauterized mucous membrane 100 will not stick to the electrode 40. Therefore, the function of the electrode 40 is maintained, and the electrode 40 can be kept used without cleaning/replacement.

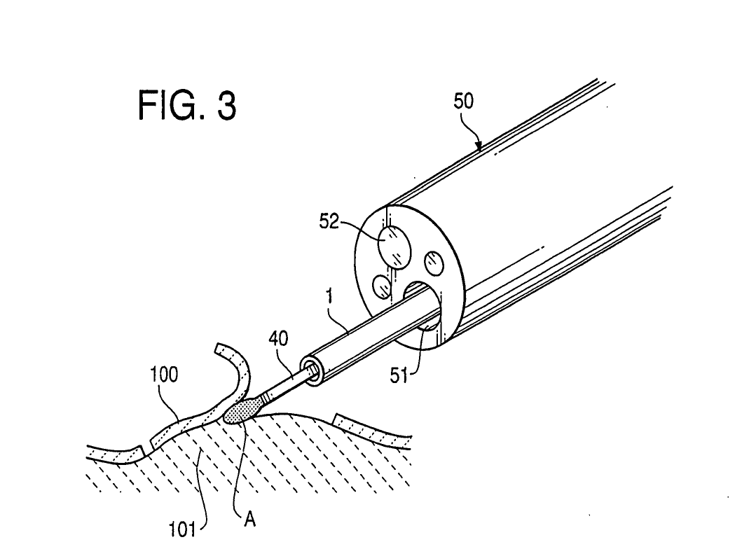

When the human tissues 100 is cut to surround the portion to be detached, the rounded portion of the electrode 40 is turned such that a plane of the electrode 40 is substantially parallel with the surface of the human tissues 100, and is inserted below the portion to be detached as shown in FIG. 3. Then, by moving the electrode 40 to scoop up the portion to be detached, the human tissues 100 can be detached from the muscular portion 101. It should be noted that, according to the embodiment, even if the electrical current flows through the electrode 40 during the detaching operation, the tissues of human tissues 100 or the like will not stick to the electrode 40.

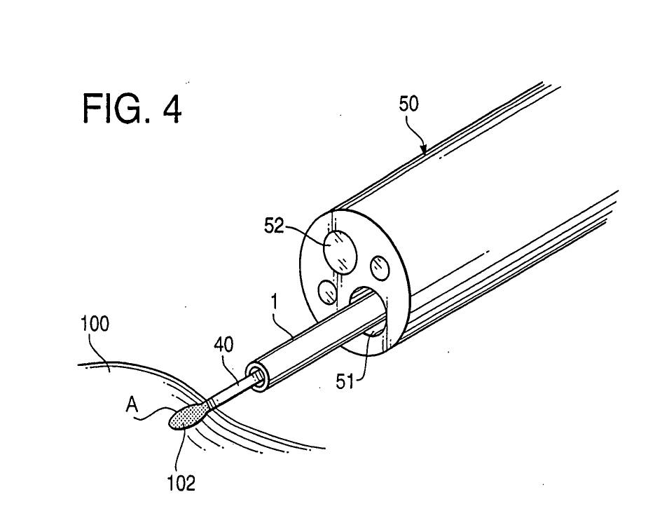

If blood vessels are cut at the detached portion and effusion of blood occurs, the user may contact the planar surface of portion A of the electrode 40 on a surface 102 where the effusion occurs with supplying the high-frequency current to the electrode 40 as shown in FIG. 4. By this surface contact with supplying the high-frequency to the electrode 40, the surface 102 where the effusion occurs and an area surrounding the portion 102 are cauterized with the high-frequency current of a relatively low current density. As the surface and the surrounding portion are cauterized, the hemostasis is done. Even in such case, the tissues of the human tissues 100 will not stick to the electrode 40.

If the electrode 40 has color as that of the stainless steel, the high-frequency electrode 40 may reflect the color of the mucous membrane as it is, which causes unclearness of a boundary, in an observed image, between the high-frequency electrode 40 and the human tissues 100. According to the embodiment, since the tip portion of the electrode 40 is coated with gold, the portion A is observed as an yellowish image, the user can clearly distinguish the electrode 40 from the human tissues 100. Therefore, the high-frequency treatment can be carried out securely.

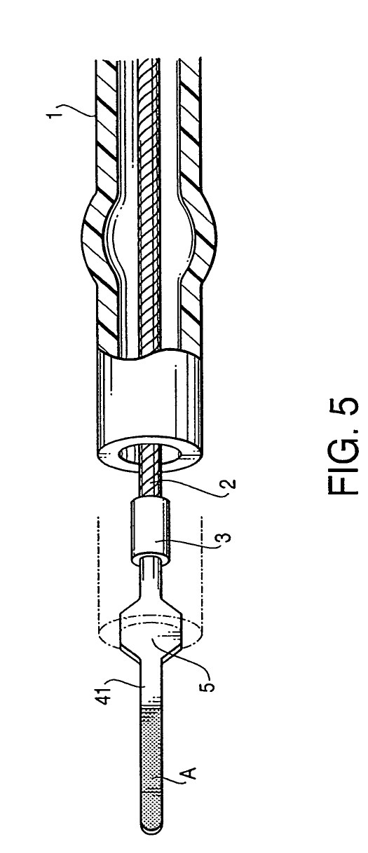

It should be noted that the present invention is not limited to the rounded planer electrode described above, but can be applied to various treatment tools for the endoscope. For example, the electrode 40 may be modified to have a needle shape, which is shown in FIG. 5 as a high-frequency electrode 41 according to a second embodiment.

In the second embodiment, the proximal end portion of the electrode 41 is formed to have a widened portion 5. By withdrawing the operation wire 2 so that the widened portion 5 tightly engages with the inner diameter of the sheath 1, the electrode 41 can be fixed to the sheath with being protruded by a predetermined amount, and the high-frequency incision and the like can be performed therewith. Instead of the configuration shown in FIG. 5, it may be possible to modify the high-frequency tool such that an electrode is completely fixed to the endoscope.

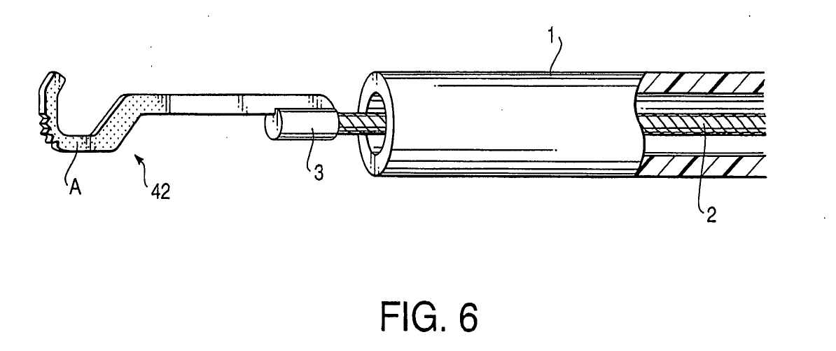

FIG. 6 is a cross-sectional side view of a tip portion of a high-frequency treatment tool according to a third embodiment of the invention. According to the third embodiment, the high-frequency electrode 42 is configured to have a shape of a hook, which is also coated with the gold A. Similarly to the above embodiments, the living tissues hardly adhere on the electrode 42 even if the high-frequency is applied and the temperature is raised.

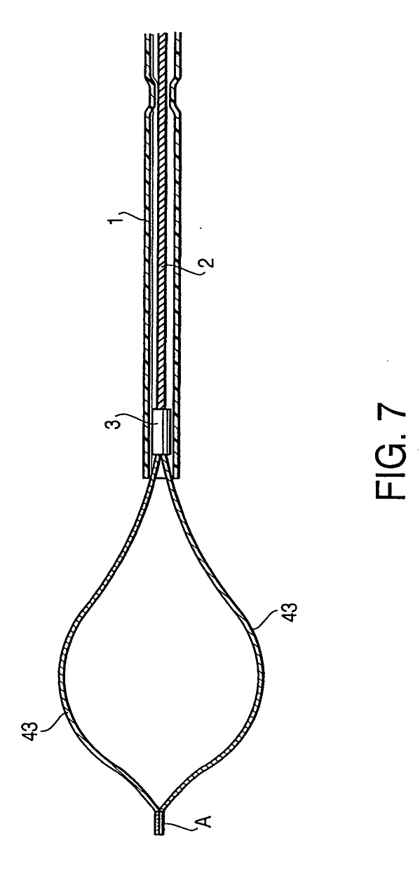

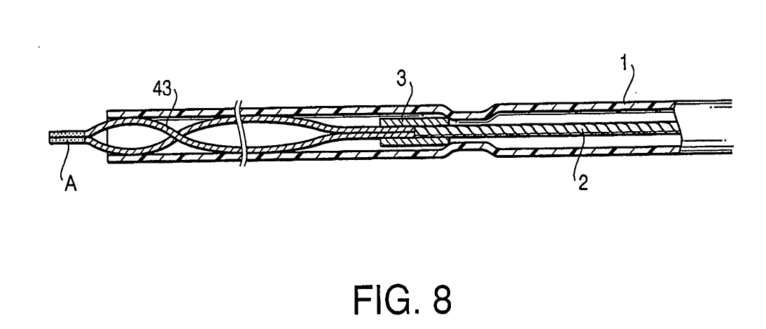

FIG. 7 is a cross-sectional side view showing a state in which a high-frequency electrode is protruded from a sheath and expanded according to a fourth embodiment of the invention. Further, FIG. 8 is a cross-sectional side view shown a state in which the high-frequency electrode is retracted and tucked into the sheath according to the fourth embodiment of the invention. According to the fourth embodiment, the high-frequency electrode 43 is formed from two wires that are made of stainless steel or tungsten alloy. The two wires are connected at their ends to have a shape of a loop that elastically expands and retracts and serves as a high-frequency snare.

In the fourth embodiment, the surface of the tip end portion A of the electrode 43 is overlaid with gold. As shown in FIG. 8, the high-frequency electrode 43 is configured to be retracted and tucked into the sheath 1 so that only the tip of the electrode 43 is protruded from the sheath 1 to perform high-frequency incision.

In the embodiments described above, the surface of the high-frequency electrodes 40, 41, 42 and 43 are coated with gold. This is based on a fact that gold is less oxidized by the heat generated when the high-frequency treatment is carried out. It should be noted, however, that the surface of the electrodes may be coated with one of platinic metal and its alloy, such as platinum, iridium, rhodium, and palladium. In addition, the coating of the surface of the electrodes is not limited to be made of plating, but also may be made of one of evaporating and ion plating.

The present disclosure relates to the subject matter contained in Japanese Patent Application No. 2004-257892, filed on Sep. 6, 2004, which is expressly incorporated herein by reference in its entirety.

What is claimed is:

1. A high-frequency treatment tool for an endoscope, comprising:
a sheath to be inserted through a forceps channel of the endoscope, the sheath being made of electrically insulating material; and
an electrode to which a high-frequency electrical current is supplied for the high-frequency treatment,
at least a part of the electrode to be contacted with mucous membrane being formed with a coating of one of gold, platinic metal and its alloy.

2. The high-frequency treatment tool according to claim 1,
wherein the electrode is made of one of stainless steel and tungsten alloy.

3. The high-frequency treatment tool according to claim 1,
wherein the coating is made of one of plating, evaporating, and ion plating.

4. The high-frequency treatment tool according to claim 1,
wherein the electrode is formed such that a tip end portion has a flat and expanded round shape.

5. The high-frequency treatment tool according to claim 1,
wherein the electrode is formed to have a shape of a hook.

6. The high-frequency treatment tool according to claim 1,
wherein the electrode is formed to have a shape of a needle.

7. A high-frequency snare for an endoscope, comprising:
a sheath to be inserted through a forceps channel of the endoscope, the sheath being made of electrically insulating material; and
an electrode to which a high-frequency electrical current is supplied for the high-frequency treatment, the electrode being connected at end portions to form a loop, and
at least a part of the electrode to be contacted with mucous membrane being coated with one of gold, platinic metal and its alloy.

8. A high-frequency snare according to claim 7,
wherein the electrode is configured to protrude from the sheath and expand outside the sheath.

9. A high-frequency snare according to claim 7,
wherein the electrode is configured to be retracted and partially tucked into the sheath so that at least a part of the electrode is protruded from the sheath to serve as a cautery tool.
